(19) United States
(12) Patent Application Publication
(10) Pub. No.: US 2020/0076005 A1
(43) Pub. Date: Mar. 5, 2020

(54) CYLINDRICAL NONAQUEOUS ELECTROLYTE SECONDARY BATTERY

(71) Applicant: SANYO Electric Co., Ltd., Daito-shi, Osaka (JP)

(72) Inventors: Yukihiro Oki, Osaka (JP); Takaki Nakao, Osaka (JP)

(73) Assignee: SANYO Electric Co., Ltd., Daito-shi, Osaka (JP)

(21) Appl. No.: 16/463,190

(22) PCT Filed: Nov. 22, 2017
(86) PCT No.: PCT/JP2017/041974

§ 371 Date: May 22, 2019

(30) Foreign Application Priority Data
Dec. 5, 2016 (JP) 2016-235822

(51) Int. Cl. H01M 10/0587; H01M 4/78; H01M 2/26

(52) U.S. Cl. CPC H01M 10/0587; H01M 2/26; H01M 4/78

(57) ABSTRACT

A nonaqueous electrolyte secondary battery according to an embodiment of the present disclosure includes: a wound electrode assembly formed by spirally winding, via a separator, a positive electrode and a negative electrode in which a negative electrode mixture layer is formed on a negative electrode core, where the negative electrode core is exposed on an outermost surface, and a fastening tape is attached to fix a winding end of the negative electrode to the outermost surface; and a package that houses the wound electrode assembly and a nonaqueous electrolyte. The winding end of the negative electrode extends from a winding edge of the positive electrode in a winding direction; a winding end of the separator extends from a winding edge of the negative electrode in the winding direction; and the fastening tape is attached to extend across the winding end of the separator.

### TECHNICAL FIELD

The present disclosure relates to a cylindrical nonaqueous electrolyte secondary battery.

### BACKGROUND ART

A cylindrical nonaqueous electrolyte secondary battery includes a wound electrode assembly formed by spirally winding a positive electrode and a negative electrode via a separator and is configured by housing the wound electrode assembly in a package. As the performance of electrical equipment, such as mobile devices, is enhanced, expectations have been growing in recent years for further increased capacity of secondary batteries as power sources therefor. For this reason, to maximize the volume energy density of a nonaqueous electrolyte secondary battery, such as a cylindrical lithium-ion battery, a configuration in which a copper foil negative electrode core of a negative electrode is exposed on the outermost circumference of a wound electrode assembly has been in practical use.

Patent Literature (PTL) 1 discloses a cylindrical nonaqueous electrolyte secondary battery in which a negative electrode current collector (negative electrode core) of a copper foil is exposed on the outermost surface of a wound electrode assembly and an active material layer is formed on only the winding inner side of the current collector at the electrode edge.

### CITATION LIST

### Patent Literature

PTL 1: Japanese Published Unexamined Patent Application No. 10-172523

### SUMMARY OF INVENTION

### Technical Problem

As in the technique described in PTL 1, a configuration in which the negative electrode core is exposed on the outermost surface of the wound electrode assembly is considered to be advantageous for enhancing volume energy density since the separator is shorter than that in a configuration in which only a separator is exposed on the outermost surface. In this configuration, however, a metal foil that is susceptible to wrinkle formation is exposed on the outermost surface of the wound electrode assembly. Accordingly, there is still room for improvement to prevent damage on the metal foil.

Particularly, in the last stage of cycles when the secondary battery is repeatedly charged and discharged or when the secondary battery is used in a low-temperature environment, the wound electrode assembly may swell significantly. Here, a fastening tape for preventing winding back is attached to the outermost surface of the wound electrode assembly. Due to such a configuration, when the wound electrode assembly swells significantly as mentioned above, wrinkles may be formed in an area of the metal foil on the outermost surface that surrounds a portion fixed with the fastening tape, and the metal foil may readily be damaged due to the wrinkles.

An object of the present disclosure is to suppress wrinkle formation in a negative electrode core in a configuration of a cylindrical nonaqueous electrolyte secondary battery in which a negative electrode core of a metal foil is exposed on the outermost surface of a wound electrode assembly.

### Solution to Problem

A cylindrical nonaqueous electrolyte secondary battery according to an embodiment of the present disclosure includes: a wound electrode assembly formed by spirally winding, via a separator, a positive electrode and a negative electrode in which a negative electrode mixture layer is formed on a negative electrode core of a metal foil, where the negative electrode core is exposed on an outermost surface, and a fastening tape is attached to fix a winding end of the negative electrode to the outermost surface; a nonaqueous electrolyte; and a package that houses the wound electrode assembly and the nonaqueous electrolyte. The winding end of the negative electrode extends from a winding edge of the positive electrode in a winding direction. A winding end of the separator extends from a winding edge of the negative electrode in the winding direction. The fastening tape is attached to extend across the winding end of the separator.

### Advantageous Effects of Invention

According to a cylindrical nonaqueous electrolyte secondary battery of the present disclosure, wrinkle formation in a negative electrode core can be suppressed in a configuration in which a negative electrode core of a metal foil is exposed on the outermost surface of a wound electrode assembly.

### BRIEF DESCRIPTION OF DRAWINGS

FIG. 1 is a cross-sectional view of a cylindrical nonaqueous electrolyte secondary battery of an exemplary embodiment.

FIG. 2 is a front view of a wound electrode assembly of the nonaqueous electrolyte secondary battery illustrated in FIG. 1.

FIG. 3 is the A-A cross-sectional view of FIG. 1.

FIG. 4 is the B-B cross-sectional view of FIG. 2 for illustrating a position at which a fastening tape is attached to the outermost surface of the wound electrode assembly of the embodiment.

FIG. 5 is a front view of a wound electrode assembly of a nonaqueous electrolyte secondary battery of a comparative example.

FIG. 6 is the C-C cross-sectional view of FIG. 5 for illustrating a position at which a fastening tape is attached to the outermost surface of the wound electrode assembly of the comparative example.

FIG. 7 is a schematic A-A cross-sectional view of FIG. 1 for illustrating, in the embodiment, a suitable range where a winding edge of the negative electrode is arranged relative to a position at which a positive electrode lead is arranged.

FIG. 8 (a) illustrates the outermost surface of a wound electrode assembly of a working example after a cycle test, and FIG. 8 (b) illustrates the outermost surface of a wound electrode assembly of the comparative example after a cycle test.

### DESCRIPTION OF EMBODIMENTS

Hereinafter, an exemplary embodiment will be described in detail. Since the drawings that will be referred to in the description of the embodiments are schematically illustrated, specific dimensions and the like of each component should be determined by taking into account the following description. The term “almost” will be explained by using “almost the same” as an example. Use of this term herein is intended to encompass not only a thing that is identical, but also a thing that is considered to be substantially the same. Moreover, the term “end” means the edge and the vicinity of the edge of an object, and the term “central portion” means the center and the vicinity of the center of an object. Shapes, materials, the number of members, and numerical values in the following description are examples for illustration and may be changed appropriately in accordance with the uses of nonaqueous electrolyte secondary batteries.

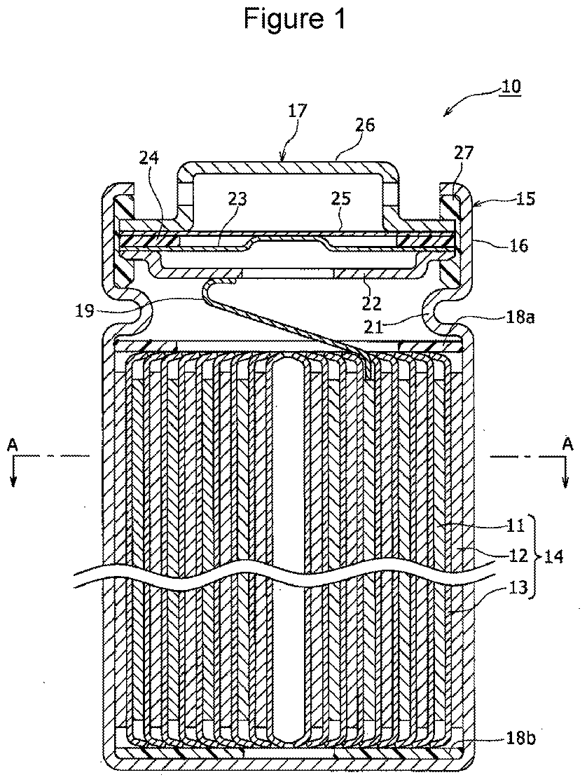

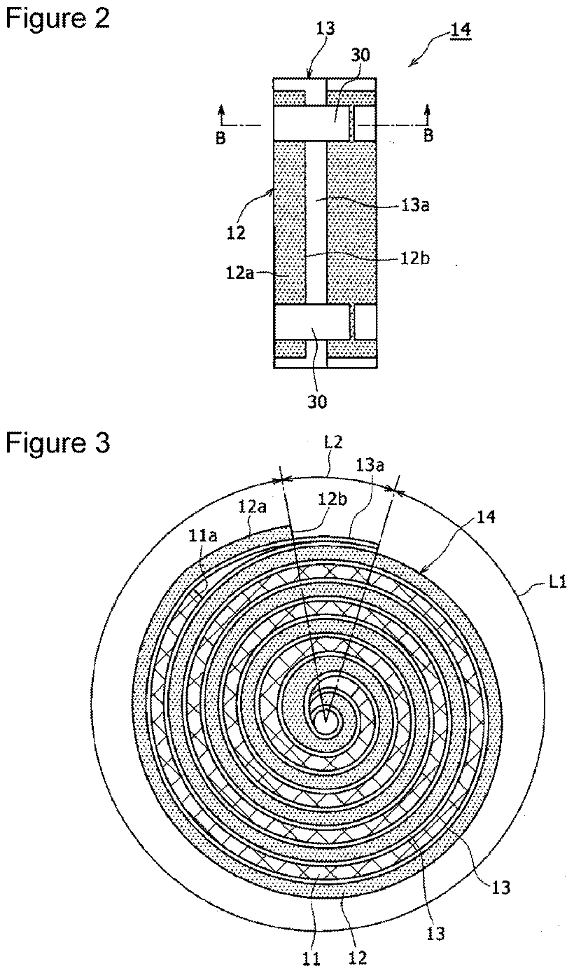

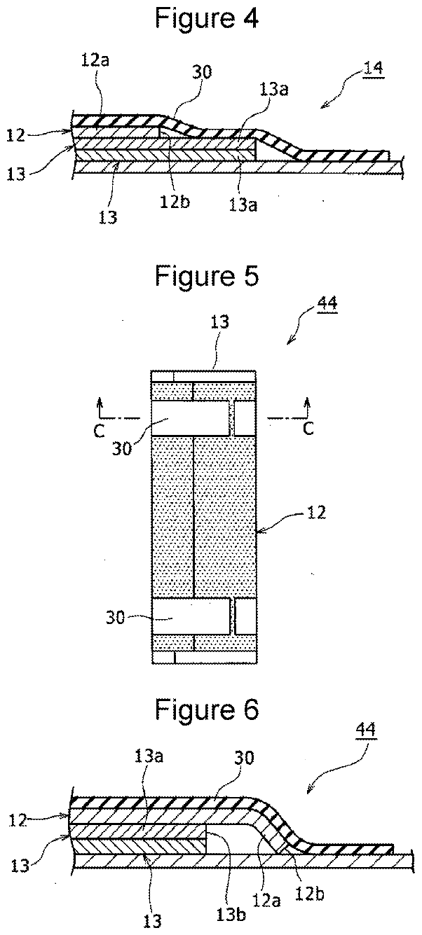

FIG. 1 is a cross-sectional view of a cylindrical nonaqueous electrolyte secondary battery 10 of an exemplary embodiment. FIG. 2 is a front view of a wound electrode assembly 14 of the nonaqueous electrolyte secondary battery 10 illustrated in FIG. 1, which is viewed from the outer diameter side. FIG. 3 is the A-A cross-sectional view of FIG. 1. FIG. 4 is the B-B cross-sectional view of FIG. 2 for illustrating a position at which a fastening tape 30 is attached to the outermost surface of the wound electrode assembly 14 according to the embodiment.

As illustrated in FIG. 1, the nonaqueous electrolyte secondary battery 10 includes the wound electrode assembly 14, a nonaqueous electrolyte (not shown), and a battery case 15 as a package. Hereinafter, the nonaqueous electrolyte secondary battery 10 is mentioned as the secondary battery 10, and the wound electrode assembly 14 is mentioned as the electrode assembly 14. The electrode assembly 14 includes a positive electrode 11, a negative electrode 12, and a separator 13 and is formed by spirally winding the positive electrode 11 and the negative electrode 12 via the separator 13 as illustrated in FIG. 3. For clarification, the positive electrode 11 is represented by a diagonal lattice portion and the negative electrode 12 is represented by a sand-like pattern portion. The negative electrode 12 is also represented by a sand-like pattern portion in FIG. 2 described hereinafter. In FIG. 1 and FIG. 3, to clarify the arrangement relationship among the positive electrode, the negative electrode, and the separator in the electrode assembly, the positive electrode, the negative electrode, and the separator are illustrated to exaggerate the respective thicknesses by decreasing the winding number compared with an actual instance.

The nonaqueous electrolyte includes a nonaqueous solvent and an electrolyte salt dissolved in the nonaqueous solvent. The nonaqueous electrolyte is not limited to a liquid electrolyte and may be a solid electrolyte, such as a gel polymer. Hereinafter, one side in the winding axis direction of the electrode assembly 14 is referred to as “the upper side” and the other side in the winding axis direction is referred to as “the lower side” in some instances.

The positive electrode 11, the negative electrode 12, and the separator 13 that constitute the electrode assembly 14 are all formed as strips and spirally wound to be stacked alternately in the radial direction of the electrode assembly 14. In the electrode assembly 14, the longitudinal direction of each electrode is the winding direction and the width direction of each electrode is the winding axis direction. As illustrated in FIG. 1, a positive electrode lead 19 that electrically connects the positive electrode 11 to a positive electrode terminal is provided, for example, at almost the center between the inner winding edge and the outer winding edge in the radial direction of the electrode assembly 14 and protrudes from the upper edge of an electrode group. The electrode group herein indicates a portion of the electrode assembly 14 that excludes leads.

Moreover, as illustrated in FIG. 3, in the electrode assembly 14, a winding end 12a of the negative electrode 12 extends from a winding edge 11a of the positive electrode 11 in the winding direction. As described hereinafter, in a portion of the negative electrode 12 that corresponds to the outermost surface of the electrode assembly 14, a negative electrode mixture layer is formed on only the winding inner side of a metal foil negative electrode core. And the negative electrode 12 is arranged on the outermost circumference of the electrode assembly 14. Further, since the negative electrode mixture layer is not formed on the winding outer side of the negative electrode 12 that is arranged on the outermost circumference, the negative electrode core is exposed on the outermost surface of the electrode assembly 14. The negative electrode core exposed on the outermost surface of the electrode assembly 14 comes into contact with the inner side surface of a metallic case body 16, which is a negative electrode terminal of the secondary battery 10. By such a configuration, the negative electrode 12 is electrically connected to the case body 16. As a result, a negative electrode lead for connecting the negative electrode 12 to the case body 16 is not necessarily needed.

In the example illustrated in FIG. 1, the case body 16, which is a flat-bottomed cylindrical metallic container, and a seal 17 constitute the metallic battery case 15 that houses the electrode assembly 14 and the nonaqueous electrolyte. Insulating plates 18a and 18b are provided on the upper side and the lower side, respectively, of the electrode assembly 14. The positive electrode lead 19 is connected to the positive electrode 11 and extends above the electrode assembly 14. The positive electrode lead 19 then extends in a through hole of the insulating plate 18a to the side of the seal 17 and is welded to the lower surface of a filter 22, which is a bottom plate of the seal 17. In the secondary battery 10, a cap 26, which is a top plate of the seal 17 that is electrically connected to the filter 22, constitutes a positive electrode terminal. Meanwhile, in the negative electrode 12, on the outermost surface of the electrode assembly 14, the negative electrode core comes into contact with the inner side surface of a cylindrical part of the case body 16, which constitutes a negative electrode terminal, and is electrically connected to the case body 16. Here, it is also possible to connect a negative electrode lead (not shown) to the negative electrode core while the negative electrode core exposed on the outermost surface of the electrode assembly 14 is in contact with the inner side surface of the cylindrical part of the case body 16. In this instance, a portion of the negative electrode lead that protrudes below the negative electrode core is electrically connected to a bottom plate of the case body 16.

Between the case body 16 and the seal 17, a gasket 27 is provided to ensure sealing of the inside of the battery case 15. The case body 16 has an overhanging portion 21 that is formed, for example, by pressing the side surface portion from the outside and that supports the seal 17. The overhang portion 21 is preferably formed circularly in the circumferential direction of the case body 16 and supports the seal 17 by using its upper surface.

The seal 17 has a stacked structure of the filter 22, a lower valve 23, an insulator 24, an upper valve 25, and the cap 26 in this order from the side of the electrode assembly 14. Each member that constitutes the seal 17 has a disk or ring shape, for example, and the members excluding the insulator 24 are electrically connected to each other. The lower valve 23 and the upper valve 25 are connected to each other in the respective central portions, and the insulator 24 is disposed between the peripheries of these valves. Upon increase in internal pressure of the battery due to abnormal heat generation, the lower valve 23 swells to the side of the cap 26 and fractures, thereby detaching the upper valve 25 from the lower valve 23. This breaks the electrical connection between the lower valve 23 and the upper valve 25. Upon further increase in internal pressure, the upper valve 25 fractures, thereby releasing gas from an opening of the cap 26.

Next, the configuration of the positive electrode 11, the negative electrode 12, and the separator 13 will be described in detail. The positive electrode 11 includes a rectangular positive electrode core and a positive electrode mixture layer. The positive electrode mixture layer contains a positive electrode active material and a binder and is formed on the positive electrode core. A suitable example of the positive electrode core is a metal foil based on aluminum or an aluminum alloy. The thickness of the positive electrode core is 5 μm to 30 μm, for example.

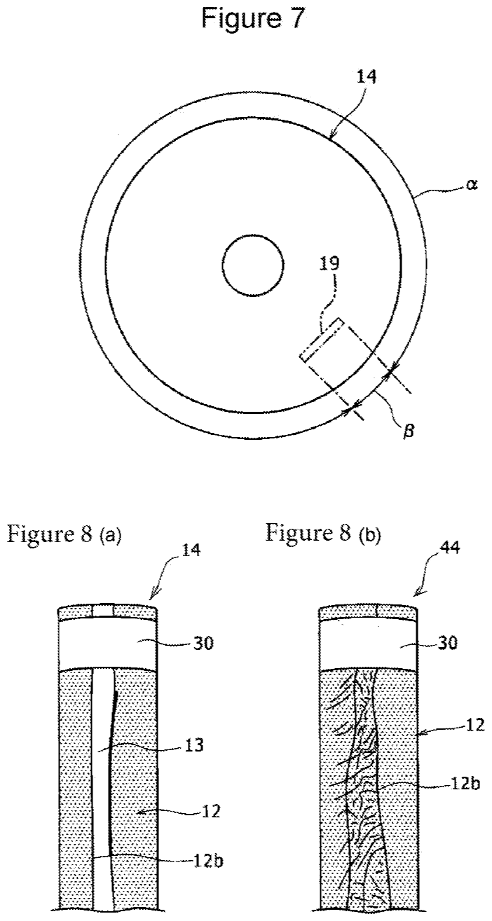

The positive electrode lead 19 is connected to an exposed surface portion of the positive electrode core of the positive electrode 11. Accordingly, in accordance with the thickness of the positive electrode lead 19, a part of the circumferential direction on the outermost surface of the electrode assembly 14 that is positioned outside the positive electrode lead 19 in the radial direction of the electrode assembly 14 slightly protrudes outside in the radial direction or has a larger radial-direction length from the winding axis center in the part of the circumferential direction on the outer surface. Being positioned outside in the radial direction means, when viewing the electrode assembly 14 from the upper side or the lower side, being positioned in a range in the circumferential direction on the outermost circumference side of the positive electrode lead between two lines that are parallel to a radial-direction line passing through the central position of the positive electrode lead 19 and that pass through each edge in the circumferential direction of the positive electrode lead 19. These two lines correspond to the two dot-dash lines in contact with each edge of arrow β in FIG. 7 described hereinafter. And the range on the outermost circumference side corresponds to the range represented by arrow β in the circumferential direction in FIG. 7.

The positive electrode mixture layer is suitably formed on each side in the thickness direction of the positive electrode core. The positive electrode mixture layer contains a positive electrode active material, a binder, and an electric conductor, for example. The positive electrode 11 can be fabricated by applying a positive electrode mixture slurry containing a positive electrode active material, a binder, an electric conductor, and a solvent, such as N-methyl-2-pyrrolidone (NMP), to both sides of a positive electrode core and compressing the resulting coating films.

Examples of the positive electrode active material include lithium transition metal oxides containing transition metal elements, such as Co, Mn, and Ni. Such lithium transition metal oxides are not particularly limited, but are preferably complex oxides represented by a general formula of Li₁₊ₓMO₂ (−0.2<x≤0.2, M includes at least one of Ni, Co, Mn, and Al). Examples of the electric conductor include carbon materials, such as carbon black, acetylene black, Ketjen black, and graphite. These carbon materials may be used alone or in combination.

Examples of the binder include fluororesins, such as polytetrafluoroethylene (PTFE) and polyvinylidene fluoride (PVdF); polyacrylonitrile (PAN); polyimides; acrylic resins; and polyolefins. In addition, these resins may be used together with carboxymethyl cellulose (CMC) or a salt thereof, polyethylene oxide (PEO), or the like. These binders may be used alone or in combination.

The negative electrode 12 includes a rectangular negative electrode core and a negative electrode mixture layer formed on the negative electrode core. The negative electrode core is formed from a metal foil based on copper or a copper alloy. The thickness of the negative electrode core is 5 μm to 30 μm, for example.

The negative electrode 12 is larger than the positive electrode 11 and has an exposed portion almost rectangular in the front view or the rear view at each end in the longitudinal direction. The negative electrode mixture layer is suitably formed on each side in the thickness direction of the negative electrode core. Meanwhile, in a portion of the negative electrode core that corresponds to the outermost circumference of the electrode assembly 14, the negative electrode mixture layer is formed on only the winding inner side of the negative electrode core to expose the negative electrode core on the outermost surface of the electrode assembly 14. The negative electrode mixture layer contains a negative electrode active material and a binder, for example. The negative electrode 12 can be fabricated by applying a negative electrode mixture slurry containing a negative electrode active material, a binder, and water to both sides of a negative electrode core and compressing the resulting coating films.

The negative electrode active material is not particularly limited provided that lithium ions can be reversibly absorbed and released. And carbon materials, such as graphite; metals to be alloyed with lithium, such as Si and Sn; and alloys and oxides thereof are preferably used. As a binder, fluororesins, PAN, polyimides, acrylic resins, polyolefins, and the like may be used as in the positive electrode. When a mixture slurry is prepared by using aqueous solvents, CMC or a salt thereof, styrene-butadiene rubber (SBR), polyacrylic acid (PAA) or a salt thereof, or the like is preferably used. These binders may be used alone or in combination.

The separator 13 has a rectangular shape larger than the negative electrode 12 in the winding axis direction (width direction) (the vertical direction in FIG. 2). For the separator 13, an ion-permeable insulating porous sheet is used. Specific examples of the porous sheet include a microporous membrane, a woven fabric, and a nonwoven fabric. The material for the separator 13 is suitably an olefin resin, such as polyethylene or polypropylene; cellulose; and the like. The separator 13 may be a multilayer structure including a cellulose fiber layer and a thermoplastic resin fiber layer, such as an olefin resin.

As illustrated in FIG. 2 and FIG. 3, a winding end 13a of the separator 13 extends from a winding edge 12b of the negative electrode 12 in the winding direction (the right direction in FIG. 2 and FIG. 3). In the examples illustrated in FIG. 3 and FIG. 4, two layers of the separators 13 overlap at the winding end, and the positions of the winding ends of the two layers are aligned in the winding direction.

As illustrated in FIG. 3, a fastening tape 30 is attached to the outermost surface of the electrode assembly 14 to fix the winding end 12a of the negative electrode 12 to the outermost surface of the electrode assembly 14. The fastening tape 30 is, for example, an insulating material tape, such as a PP tape. The PP tape is a tape in which an adhesive layer is formed on either side of a porous or nonporous polypropylene substrate. The fastening tape 30 is attached to the negative electrode core of the negative electrode 12 at the winding edge 12b and in the outermost surface portion that is positioned in the winding-back direction. At the same time, the intermediate portion of the tape extends across the winding end 13a of the separator 13. In this instance, the fastening tape 30 is also attached to the winding end 13a of the separator 13 as illustrated in FIG. 4. In the example illustrated in FIG. 2, the fastening tapes 30 are attached to two positions near each edge in the winding axis direction on the outermost surface of the electrode assembly 14. The fastening tape 30 may be attached to only one position in the middle portion in the winding axis direction on the outermost surface of the electrode assembly 14 or may be attached to three or more positions apart from each other in the winding axis direction on the outermost surface of the electrode assembly 14. In the example illustrated in FIG. 2, each fastening tape 30 is attached to cover almost the entire circumference of the electrode assembly 14. The fastening tape 30, however, does not need to be attached over almost the entire circumference of the electrode assembly 14 provided that the winding end 12a of the negative electrode 12 can be fixed to the outermost surface of the electrode assembly 14.

According to the secondary battery 10 described above, wrinkle formation in a metal foil negative electrode core can be suppressed in a configuration in which the negative electrode core is exposed on the outermost surface of the electrode assembly 14.

To explain such suppressive effects on wrinkle formation, a comparative example will be first described. FIG. 5 is a front view of a wound electrode assembly of a nonaqueous electrolyte secondary battery of a comparative example. FIG. 6 is the C-C cross-sectional view of FIG. 5 for illustrating a position at which a fastening tape 30 is attached to the outermost surface of a wound electrode assembly 44 of the comparative example. Hereinafter, the wound electrode assembly 44 is mentioned as the electrode assembly 44. In the comparative example illustrated in FIG. 5 and FIG. 6, different from the embodiment illustrated in FIG. 1 to FIG. 4, a winding end 12a of a negative electrode 12 extends from the winding edge 13b of the separator 13 in the winding direction. Accordingly, the winding end of the separator 13 does not extend from the winding edge 12b of the negative electrode 12 in the winding direction in the comparative example. In addition, the fastening tape 30 is attached to the negative electrode core of the negative electrode 12 that is exposed on the outermost surface at the winding end 12a and attached to, across the winding edge 12b, the portion that is positioned in the winding-back direction, without being attached to the separator 13.

In a nonaqueous electrolyte secondary battery, an electrode assembly 14 may swell significantly in the last stage of cycles when charging and discharging are repeated at a high rate or when used in a low-temperature environment. In the above-mentioned comparative example, the fastening tape 30 is directly attached to only the negative electrode core without extending across the separator 13. In this instance, upon significant swelling of the electrode assembly 44, the winding edge 12b of the negative electrode core directly and forcefully comes into contact with an inner opposing portion of the negative electrode core while the outermost surface of the negative electrode core is firmly pressed against the inner side surface of a cylindrical portion of the case body 16 (see FIG. 1). When the electrode assembly 44 repeats swelling and contraction, the winding edge 12b of the negative electrode core is displaced in the circumferential direction and readily dragged by the opposing portion of the negative electrode core. Consequently, wrinkles tend to be formed in the negative electrode core. When wrinkles are formed in the negative electrode core, there is a risk of causing a short circuit, for example, through tearing of the separator and the like that are positioned inside by projections of the wrinkles. Accordingly, wrinkle formation is required to be suppressed.

In contrast, according to the embodiment illustrated in FIG. 4, the winding end of the separator 13 extends from the winding edge 12b of the negative electrode core in the winding direction. Moreover, the fastening tape 30 extends across the winding end 13a of the separator 13 while being attached thereto by the portion that extends from the winding edge 12b of the negative electrode core in the winding direction. Simultaneously, the tape is attached to the portion of the negative electrode core that is positioned in the winding-back direction and exposed on the outermost surface. Due to this configuration, the separator 13, which is flexible and enables easy sliding of a member with which contact has been made, directly faces the winding edge 12b of the negative electrode core. As a result, the separator 13 acts as a sliding material and a cushioning material, thereby suppressing dragging of the winding edge 12b of the negative electrode core. Thus, wrinkle formation in the negative electrode core can be suppressed on the outermost surface of the electrode assembly 14. In FIG. 4 and in FIG. 6 described hereinafter, large gaps are illustrated between the inner surface of the fastening tape 30 and winding edges of the negative electrode 12 and the separator 13 since the thickness of each element of the electrode assembly 14 is illustrated in an enlarged manner. However, such gaps are actually nonexistent or almost nonexistent.

Further, in the embodiment, a ratio of length L1 in the winding direction of the negative electrode 12 that is exposed on the outermost surface of the electrode assembly 14 to length (L1+L2) of one turn of the negative electrode 12 in the winding-back direction from the winding edge 12b is preferably ¾ or more, as illustrated in FIG. 3. In this instance, a ratio of length L2 of the separator 13 that extends from the winding edge 12b of the negative electrode 12 in the winding direction to the length of one turn of the negative electrode 12 in the winding-back direction from the winding edge 12b is ¼ or less. According to the above-described preferable configuration, the volume energy density of a battery can be increased. Moreover, in the embodiment, the length L2 in the winding direction of the separator 13 that extends from the winding edge 12b of the negative electrode is preferably 0.5 mm or more. According to this preferable configuration, wrinkle formation can be further effectively suppressed at the winding end of the negative electrode.

FIG. 7 is a schematic A-A cross-sectional view of FIG. 1 for illustrating, in the embodiment, a suitable range where the winding edge 12b of the negative electrode 12 is arranged relative to the position at which the positive electrode lead 19 is arranged. FIG. 7 schematically illustrates the cross-section of the electrode assembly 14 by using a double circle that represents the winding inner edge and the winding outer edge. The positive electrode lead 19 is arranged in part of the circumferential direction of the electrode assembly 14 between the winding inner edge and the winding outer edge. Due to such an arrangement, on the outermost surface of the electrode assembly 14, a part of the circumferential direction that is positioned outside the positive electrode lead 19 in the radial direction of the electrode assembly 14 protrudes outside in the radial direction or has a larger radial-direction length on the outermost surface from the winding axis center. Consequently, the outermost surface in the range represented by arrow β in the circumferential direction of the electrode assembly 14 in FIG. 7 becomes susceptible to forceful contact with the inner side surface of the battery case when the electrode assembly 14 swells. Accordingly, when the winding edge 12b of the negative electrode is positioned in the range represented by arrow β, wrinkles are more likely to be formed at the winding end 12a. For this reason, in the embodiment, the winding edge 12b of the negative electrode is preferably arranged anywhere within the range represented by arrow α in the circumferential direction of FIG. 7 on the outermost surface of the electrode assembly 14 so as not to be positioned outside the positive electrode lead 19 in the radial direction of the electrode assembly 14.

### EXAMPLES

Hereinafter, the present disclosure will be further described with the Examples. The present disclosure, however, is not limited to these Examples.

### Example 1

[Fabrication of Positive Electrode]

As a positive electrode active material, a lithium nickel cobalt aluminum complex oxide represented by LiNi_{0.82}Co_{0.12}Al_{0.06}O₂ was used. A positive electrode mixture slurry was prepared by: mixing 100 parts by mass of the positive electrode active material, 2 parts by mass of acetylene black (AB), and 3 parts by mass of a binder; and further adding an appropriate amount of N-methyl-2-pyrrolidone (NMP). The positive electrode mixture slurry was then uniformly applied to both sides of an elongated positive electrode core formed from a 15 μm-thick aluminum foil by a doctor blade method. Subsequently, the resulting coating films were dried by heat-treating at a temperature of 100° C. to 150° C. in a heated drying apparatus to remove NMP. Positive electrode mixture layers were formed by rolling the coating films with a roll press to have an electrode sheet thickness of 150 μm. Subsequently, the elongated positive electrode core in which positive electrode mixture layers had been formed was cut into a predetermined electrode size, thereby fabricating a positive electrode 11 in which positive electrode mixture layers are formed on both sides of a predetermined-size positive electrode core.

[Fabrication of Negative Electrode]

A negative electrode mixture slurry was prepared by mixing graphite as a negative electrode active material, styrene-butadiene rubber (SBR) as a binder, and carboxymethyl cellulose (CMC) as a thickening agent in a weight ratio of 96:2:2 and further adding an appropriate amount of water to the resulting mixture. The negative electrode mixture slurry was then uniformly applied to both sides of a negative electrode core formed from a copper foil, and the resulting coating films were dried by heat-treating at a temperature of 100° C. to 150° C. in a heated drying apparatus to remove water. Negative electrode mixture layers were formed by rolling the coating films with a roll press to have an electrode sheet thickness of 160 μm. Subsequently, the elongated negative electrode core in which negative electrode mixture layers had been formed was cut into a predetermined electrode size, thereby fabricating a negative electrode 12 in which negative electrode mixture layers are formed on a predetermined-size negative electrode core.

[Preparation of Nonaqueous Electrolyte Solution]

Ethylene carbonate (EC), ethyl methyl carbonate (EMC), and dimethyl carbonate (DMC) were mixed in a volume ratio of 25:30:45, and in a weight ratio relative to the resulting mixture as a whole, 2 parts by weight of vinylene carbonate (VC) was added to the mixture. A nonaqueous electrolyte solution was prepared by dissolving LiPF₆ at a concentration of 1.4 mol/L in the prepared mixed solvent.

[Fabrication of Battery]

A wound-type electrode assembly 14 was fabricated by attaching an aluminum positive electrode lead to the positive electrode 11 and spirally winding the positive electrode 11 and the negative electrode 12 via a 16 μm-thick PE separator. A cylindrical secondary battery 10 having an outer diameter of 21 mm and a height of 70 mm was fabricated by: housing the electrode assembly 14 in a flat-bottomed cylindrical case body of a battery case; feeding the nonaqueous electrolyte solution to the case body; and sealing an opening of the case body with a gasket and a seal. The secondary battery 10 was designed to have a 21700 size and a battery capacity of 4300 mAh.

Further, in Example 1, a ratio of the negative electrode core and the separator 13 on the outermost surface of the electrode assembly 14 was set as shown in Table 1. Here, the outermost surface of the electrode assembly 14 means the winding outer side on the outermost circumference of the electrode assembly. In Table 1, “ratio of negative electrode core (copper foil) on outermost circumference” indicates a ratio of the negative electrode core in the circumferential direction on the outermost surface of the electrode assembly, and “ratio of separator on outermost circumference” indicates a ratio of the separator 13 in the circumferential direction on the outermost surface of the electrode assembly. Specifically, a ratio of the negative electrode core in the circumferential direction on the outermost surface of the electrode assembly 14 is 99.2% and a ratio of the separator 13 is 0.8%. In this instance, at the winding end of the separator 13, the length of the separator that extends from the winding edge of the negative electrode core was 0.5 mm.

TABLE 1

| | Ratio of | | | Wrinkles in |
|---|---|---|---|---|
| | negative electrode | Ratio of | | negative electrode |
| | core (copper foil) | separator | | core on outermost |
| | on outermost | on outermost | | surface after |
| | circumference | circumference | | cycle test |
| Comparative | 100% | 0% | | Present |
| Example 1 | | | | |
| Example 1 | 99.2% | 0.8% | (0.5 mm) | Absent |
| Example 2 | 75% | 25% | | Absent |
| Example 3 | 91% | 9% | (5 mm) | Absent |

### Example 2

As shown in Table 1, in Example 2, a ratio of the negative electrode core in the circumferential direction on the outermost surface of the electrode assembly 14 is 75% and a ratio of the separator 13 is 25%. Example 2 has the same configuration as Example 1 in other aspects.

### Example 3

In Example 3, a ratio of the negative electrode core in the circumferential direction on the outermost surface of the electrode assembly 14 is 91% and a ratio of the separator 13 is 9%. In this instance, at the winding end of the separator 13, the length of the separator that extends from the winding edge of the negative electrode core was 5 mm. Example 3 has the same configuration as Example 1 in other aspects.

### Comparative Example 1

As shown in Table 1, in Comparative Example 1, a ratio of the negative electrode core in the circumferential direction on the outermost surface of the electrode assembly 14 is 100%, and the configuration is the same as the configuration illustrated in FIG. 5 and FIG. 6. Comparative Example 1 has the same configuration as Example 1 in other aspects.

[Test Method]

The secondary batteries of the above-described Examples 1 to 3 and Comparative Example 1 underwent a charging/discharging cycle test under the following test conditions, and the presence or the absence of wrinkles formed on the outermost surface of the electrode assembly was observed.

[Test Conditions]

The environmental temperature for a test is −5° C. For charging, a constant current/constant voltage (CCCV) charging mode was employed. Specifically, a secondary battery underwent constant current charging while retaining a charging current of 4.30 A until a battery voltage rose to reach 4.3 V, followed by constant voltage charging while retaining the battery voltage of 4.3 V until the charging current reached 86 mA. The secondary battery was discharged after resting for 20 minutes. For discharging, a constant current (CC) discharging mode was employed. Specifically, the secondary battery was discharged while retaining a discharge current of 4.30 A until the battery voltage reached 2.5 V. This charging/discharging cycle was repeated 500 times. The secondary battery was disassembled after 500 cycles, and the presence or the absence of wrinkles formed in the negative electrode core on the outermost surface of the electrode assembly was visually observed.

[Test Results]

FIG. 8 (a) illustrates the outermost surface of the electrode assembly 14 of Example 3 after the cycle test, and FIG. 8 (b) illustrates the outermost surface of the electrode assembly 14 of Comparative Example 1 after the cycle test.

Table 1 shows the presence or the absence of wrinkles formed in the negative electrode core on the outermost surface of the electrode assembly after the cycle test. In Comparative Example 1, wrinkles were formed in the negative electrode core on the outermost surface of the electrode assembly 44 after the cycle test, as is clear from the test result in Table 1 and FIG. 8 (b). In Comparative Example 1, the negative electrode core presumably became susceptible to wrinkle formation due to direct and forceful contact of the winding edge of the negative electrode core with an inner opposing portion of the negative electrode core.

In contrast, in all of Examples 1 to 3, no wrinkles were observed in the negative electrode core on the outermost surface of the electrode assembly 14 after the cycle test, as is clear from the test results in Table 1 and FIG. 8 (a). In all of Examples 1 to 3, the separator 13 is disposed between the winding edge of the negative electrode core and an inner portion of the negative electrode core positioned in the winding-back direction such that the separator 13 directly faces the winding edge of the negative electrode core. Due to this configuration, presumably, the separator 13 acted as a sliding material and a cushioning material, and the negative electrode core became less susceptible to wrinkle formation.

### REFERENCE SIGNS LIST

10 Nonaqueous electrolyte secondary battery (secondary battery)
11 Positive electrode
11a Winding edge
12 Negative electrode
12a Winding end
12b Winding edge
13 Separator
13a Winding end
13b Winding edge
14 Wound electrode assembly (electrode assembly)
15 Battery case
16 Case body
17 Seal
18a, 18b Insulating plate
19 Positive electrode lead
21 Overhang portion
22 Filter
23 Lower valve
24 Insulator
25 Upper valve
26 Cap
27 Gasket
30 Fastening tape
44 Wound electrode assembly (electrode assembly)

1. A cylindrical nonaqueous electrolyte secondary battery comprising:
a wound electrode assembly formed by spirally winding, via a separator, a positive electrode and a negative electrode in which a negative electrode mixture layer is formed on a negative electrode core of a metal foil, wherein the negative electrode core is exposed on an outermost surface, and a fastening tape is attached to fix a winding end of the negative electrode to the outermost surface;
a nonaqueous electrolyte; and
a package that houses the wound electrode assembly and the nonaqueous electrolyte, wherein:
the winding end of the negative electrode extends from a winding edge of the positive electrode in a winding direction;
a winding end of the separator extends from a winding edge of the negative electrode in the winding direction; and
the fastening tape is attached to extend across the winding end of the separator.

2. The cylindrical nonaqueous electrolyte secondary battery according to claim 1, wherein:
a ratio of the length in the winding direction of the negative electrode that is exposed on the outermost surface of the wound electrode assembly to the length of one turn in a winding-back direction from the winding edge of the negative electrode is ¾ or more; and
the length in the winding direction of the separator that extends from the winding edge of the negative electrode is 0.5 mm or more.

3. The cylindrical nonaqueous electrolyte secondary battery according to claim 1, wherein:
a positive electrode lead that extends outwards from the positive electrode in a winding axis direction is connected to the positive electrode; and
the winding edge of the negative electrode is arranged not to be positioned outside the positive electrode lead in a radial direction of the wound electrode assembly.
